(19) United States
(12) Patent Application Publication
(10) Pub. No.: US 2012/0310533 A1
(43) Pub. Date: Dec. 6, 2012

(54) Magic Compass

(75) Inventor: Steven James Parlin, Brentwood, NH (US)

(73) Assignee: Steven James Parlin, Brentwood, NH (US)

(21) Appl. No.: 13/441,062

(22) Filed: Apr. 6, 2012

Related U.S. Application Data
(60) Provisional application No. 61/516,678, filed on Apr. 7, 2011.

(51) Int. Cl. G01C 21/00

(52) U.S. Cl. 701/491

(57) ABSTRACT

An apparatus and method for providing navigation and other information via a motor driven dial in response to the operator's voice commands.

### CROSS-REFERENCE TO RELATED APPLICATIONS

This application is a continuation of U.S. provisional patent application Ser. No. 61/516,678, filed Apr. 7, 2011 and entitled “Magic Compass” incorporated herein by reference in its entirety.

| Provisional Patent | | |
|---|---|---|
| Application Number | Filing Date | Confirmation No. |
| 61/516,678 | Apr. 07, 2011 | 7189 |

### STATEMENT REGARDING FEDERALLY SPONSORED RESEARCH OR DEVELOPMENT

Not Applicable

### BACKGROUND OF THE INVENTION

1. Field of the Invention

The present invention is directed generally to mobile electronics and communications, and, more specifically, to a mobile unit and system having voice controlled navigation and wireless communication with a mechanical indicator output.

2. Description of the Background

This invention relates to the navigation, tracking and communication through GPS, voice recognition and wireless technology. In particular, the invention relates to the creation of a magical experience utilizing a robotic motor and digital compass for dial indication of data collected and processed by said device.

### BRIEF SUMMARY OF THE INVENTION

A purpose of the invention is to create a magical experience for persons by utilizing the technologies described herein in the form of a “magic compass”.

The main advantages of the invention are multi-fold.
1) By using GPS as a method for tracking, guest traffic can be monitored.
2) By using active RFID in conjunction with GPS guest traffic can be monitored indoors as well.
3) By using active RFID as a communication mechanism, a very large number of users can be on the network at any given time.
4) Using long range active RFID provides a greater range than that of traditional RFID, Bluetooth, etc.
5) By displaying the outputs using a motor driven mechanical dial, technology can be hidden, giving way to a magical experience.
6) By using voice recognition as the input, the device interface becomes simplified for a larger range of users.
7) The size and weight of the device allow for it to hang from a neck lanyard which also maintains the optimal distance for the voice recognition circuit and microphone.

The invention described herein is a device that utilizes a voice recognition system, GPS, digital compass, RFID tag, and stepper motor system to answer the user's voice query by moving a mechanical dial; thereby creating a seemingly “magical” experience for said user.

In use, a preferred embodiment of the invention is operated by speaking a command word or phrase in order to receive directions and/or information via the mechanical dial on the compass surface.

In broad terms, a preferred embodiment of the apparatus is comprised of a GPS system on chip, a tilt-compensated digital compass, an active digital read/write RFID tag, a voice recognition system and microphone, a micro-stepper motor and driver chip, a dial indicator, a rechargeable battery, and an outer case with interchangeable faceplate. Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### BRIEF DESCRIPTION OF THE SEVERAL VIEWS OF THE DRAWINGS

The features of the invention will be better understood by reference to the accompanying drawings which illustrate presently preferred embodiments of the invention. In the drawings:

FIG. 1 is a wiring schematic of the disclosed invention where the preferred embodiments are detailed.

FIG. 2 is a drawing of the disclosed invention where the preferred embodiments are contained in a compass casing, where said compass is used to provide navigation and other information to the operator.

The following reference numerals are used to indicate the parts and environment of the invention on the drawings:
101 voice recognition chip
102 microphone
103 push button
104 I2C bus
105 digital compass
106 GPS chip
107 robotic motor driver
108 robotic motor
109 GPS antenna
110 active RFID tag
201 interchangeable compass casing
202 compass window
203 compass dial
204 push button
205 microphone
206 keychain ring

### DETAILED DESCRIPTION OF A PREFERRED EMBODIMENT OF THE INVENTION

While other inventions address the use of GPS systems using voice as an input, and other inventions address the use of RFID devices for transmitting location data, no previous invention presents the points of novelty of the current invention. The proposed method and apparatus allows a person to use voice command to query direction and other information which is answered via the movement of a mechanical dial indicator. The various uses of the current invention include but are not limited to theme park information, navigation, security, and POS interactions.

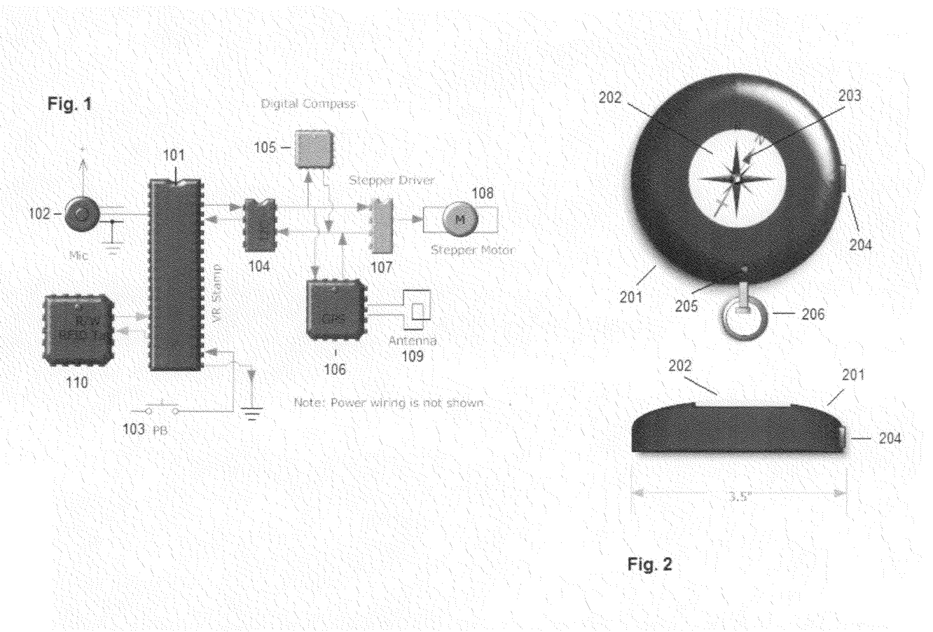

FIG. 1 illustrates a system schematic of the preferred embodiment of the invention using a commercially available voice recognition chip 101 which contains the host application and device processing functions. The voice recognition chip 101 receives voice input from the user via a microphone 102 as well as GPS location from a GPS chip 106 and antenna 109. Heading input is provided from tilt compensated digital compass 105. To simplify the I/O schematic an I2C bus 104 chip can be used to allow for multiple sensor input over two pins on the voice recognition chip 101. The voice recognition chip 101 provides two outputs based on the processed inputs. One output is a digital transmission via an active RFID tag 110. The second output method is via a stepper driver 107 and stepper motor 108.

FIG. 2 illustrates a “magic compass” device where the preferred embodiments of the invention detailed in FIG. 1 are contained within a casing 201 resembling a large pocket watch. The user activates said device by depressing the push button 204 and speaking a query into the microphone 205. The device maintains the optimal distance from the user's mouth by attaching to a neck lanyard fastened to the keychain ring 206. The answer to the user query, be it directions or dial indication of any kind is viewed through the compass window

The true scope of the present invention is not limited to the presently preferred embodiments disclosed herein. As will be understood by those skilled in the art, for example, different components, such as processors or chipsets, can be chosen in the design, packaging, and manufacture of the various elements of the present invention. The discussed embodiments of the present invention have generally relied on the availability of commercial chipsets, however many of the functions disclosed herein can also be implemented by a designer using discrete circuits and components.

Although some embodiments are shown to include certain features, the applicant(s) specifically contemplate that any feature disclosed herein may be used together or in combination with any other feature on any embodiment of the invention. It is also contemplated that any feature may be specifically excluded from any embodiment of an invention.

The invention claimed herein is:

1. A navigation and information delivery system where said system comprises a portable handheld device containing circuitry allowing voice recognition, GPS navigation, and wireless communication, where feedback is provided via a directional dial.

2. A navigation and information delivery system where said system comprises a portable handheld device containing circuitry allowing voice recognition, GPS navigation, and wireless communication, where the primary method of feedback is provided via a mechanical dial output for purposes of creating a magical experience.

3. The system as recited in claim 2, wherein a secondary output is provided to the user via a speaker located in said device.

4. The system as receipted in claim 1 and claim 2, wherein the wireless communication with nearby computer systems is provided via long range RFID circuitry.

5. The system as recited in claim 1 and claim 2, wherein the wireless communication with nearby computer systems is provided via Bluetooth™ circuitry.

6. The system as recited in claim 1 and claim 2, wherein the wireless communication with nearby computer systems is provided via WiFi circuitry.

7. The system as recited in claim 2, where the mechanical dial operates via a stepper motor.

8. The system as receipted in claim 2, where the mechanical dial operates via a dc motor and encoder system.

9. The system as receipted in claim 1, where the indication is provided by an LCD output controlled by the embedded software.
